(19) United States
(12) Patent Application Publication
(10) Pub. No.: US 2024/0369593 A1
(43) Pub. Date: Nov. 7, 2024

(54) METHOD FOR DETECTING CONTACTS ON A VEHICLE

(71) Applicant: Robert Bosch GmbH, Stuttgart (DE)

(72) Inventors: Martin Klein, Brackenheim (DE); Simon Koenig, Moeckmuehl (DE)

(21) Appl. No.: 18/568,048

(22) PCT Filed: May 23, 2022
(86) PCT No.: PCT/EP2022/063917

§ 371 Date: Dec. 7, 2023

(30) Foreign Application Priority Data
Jun. 16, 2021 (DE) 10 2021 206 166.4

(51) Int. Cl. G01P 15/00

(52) U.S. Cl. CPC G01P 15/00

(57) ABSTRACT

A method for detecting contacts on a vehicle. In the method, signals from at least two sensor are evaluated and compared to one another, wherein at least one signal strength-independent property of the signals is taken into account.

### FIELD

The present invention relates to a method for detecting contacts on a vehicle, in particular a motor vehicle, and to an arrangement for carrying out the method. The present invention also relates to a computer program and to a machine-readable storage medium.

### BACKGROUND INFORMATION

In vehicles or motor vehicles, so-called restraining means or restraint systems are used to passively protect the vehicle occupants. In this respect, a distinction is made between passive systems, e.g., the shape of a seat with pronounced lateral support, and active systems, such as airbags, which are actuated and activated only when needed, i.e., during a collision.

German Patent Application No. DE 10 2006 044 444 A1 describes a device and a method for actuating restraining means or personal protection means. In this case, an accident sensor system generates a first signal. The personal protection means are actuated as a function of a frequency of a second signal derived from the first signal. In this case, the frequency is determined as a function of a first length of a first signal curve of the second signal and a second length of a second signal curve of the summed-up second signal.

A device and method for better detection of a type and/or a severity of a collision of a vehicle with an object are described in German Patent Application No. DE 10 2007 052 159 A1. In this case, a classification and a threshold adjustment are carried out by selecting features and correlating features of several sensors, in order to accelerate an activation of a personal protection system. In this way, safe triggering of the personal protection means is to be ensured.

The methods described in the two above-mentioned applications are limited to the use of a signal evaluation for the actuation of restraint systems.

For many years, airbag control units with peripheral sensors have been used to detect safety-relevant accidents. However, minor damage is generally not detected as long as electrical components are not damaged. The detection of minor damage may be of interest for a variety of reasons. This inter alia includes damage caused to another vehicle, object, or person, and also damage to one's own vehicle by others. In this way, a possible hit and run may be prevented.

The detection of contacts and minor damage has so far been the responsibility of the driver. However, this can also be carried out, or supported, by an assistance system. It should be taken into consideration that such detection becomes increasingly important as autonomous driving evolves and as car-sharing offers increase. Some methods are described in the related art in this area.

A method and a device for detecting damage to a vehicle, in particular to a parked vehicle, are described in German Patent Application No. DE 10 2016 210 773 A1. Used in this case are a first sensor unit with at least one sensor of a first sensor type for acquiring first measurement data, a second sensor unit with a sensor of a second sensor type for acquiring second measurement data, a third sensor unit with at least one sensor of a third sensor type for acquiring third measurement data, an evaluation unit and a communication interface. By combined evaluation of the measurement data, damage to the vehicle is detected. Information about the damage is output via the communication interface.

A method and a device for detecting glass breakage in a vehicle that is preferably parked are described in German Patent Application No. DE 10 2018 205 950 A1. In this case, two sensor units are used to acquire measurement data independent of one another. By combined evaluation of the measurement data, a glass breakage is detected.

### SUMMARY

According to the present invention, a method and an arrangement are provided. A computer program and a machine-readable storage medium are also provided. Example embodiments of the present invention are disclosed herein.

The method according to the present invention is used to detect contacts on a vehicle, in particular contacts that lead to minor damage. According to an example embodiment of the present invention, in the method, signals from at least two sensors are evaluated and compared to one another. In doing so, at least one signal strength-independent property of the signals is taken into account. This means that this property is first determined in the signals and that particular properties of different signals are subsequently compared to one another.

It was thus recognized that smaller damages and contacts are very difficult to detect and to separate from signals caused by driving maneuvers. In particular, the signal strength can be significantly greater in driving maneuvers than in the case of small damages or contacts. With the method presented, it is now possible to detect local damage or contact or to achieve separation from a global maneuver relating to the entire vehicle.

Due to the strong sensor signals during driving maneuvers, the detection of small damages or contacts has so far been strongly limited. This is to be achieved both by comparing two or more sensors at different, in particular opposite, points in the vehicle and by signal strength-independent properties, such as the frequency of the signals.

According to an example embodiment of the present invention, in the method, acceleration signals are received in one embodiment at different points in the vehicle in order to detect in particular small and minor damage.

Small damages in this context are typically determined via the type of the cause. This can, for example, include driving into a moving box, a baby car seat, other vehicles, or fixed obstacles. In addition, this includes third-party damage, e.g., by impacts, kicks or shopping cart collisions.

The ultimate extent of the damages to the vehicle can be very different in the individual cases. This can include: no damage at all, scratches, up to dents or broken plastic parts. This can also depend on the sensitivity of the detection. The method considered herein for detecting damages can thus also be described as a method for detecting contacts.

According to an example embodiment of the present invention, for each sensor, signal strength-independent properties, such as the frequency, that describe the properties of the contact are determined. For example, the frequency depends on the stiffness of the contact partner. In addition, signal strength-dependent properties are compared against the properties of other sensors in order to separate local excitations that are typical of small damages, from driving maneuvers.

The use of signal strength-independent properties makes it possible to separate small damages and driving maneuvers, which are very difficult to separate with previous means.

According to an example embodiment of the present invention, the described arrangement is used to carry out the presented method and is, for example, implemented in hardware and/or software. The arrangement can be integrated in or configured as a control unit of a vehicle, in particular of a motor vehicle.

Further advantages and configurations of the present invention arise from the description and the figures.

It goes without saying that the aforementioned features and the features yet to be explained below can be used not only in the respectively specified combination but also in other combinations or on their own, without leaving the scope of the present invention.

### BRIEF DESCRIPTION OF THE DRAWINGS

FIG. 1 shows a schematic, highly simplified representation of a vehicle with an arrangement for carrying out a method according to an example embodiment of the present invention.

FIG. 2 shows a flow chart of a possible sequence of a method according to an example embodiment of the present invention.

FIG. 3 shows a signal curve for a sinusoidal acceleration with circular frequencies of 600 or 300 Hz.

FIG. 4 shows a corresponding diagram for the integral of the sinusoidal acceleration of FIG. 3.

FIG. 5 shows the corresponding second integral for the sinusoidal acceleration of FIG. 3.

FIG. 6 shows an acceleration signal and the corresponding length of the acceleration signal.

### DETAILED DESCRIPTION OF EXAMPLE EMBODIMENTS

The present invention is illustrated schematically in the figures on the basis of embodiments and is described in detail below with reference to the figures.

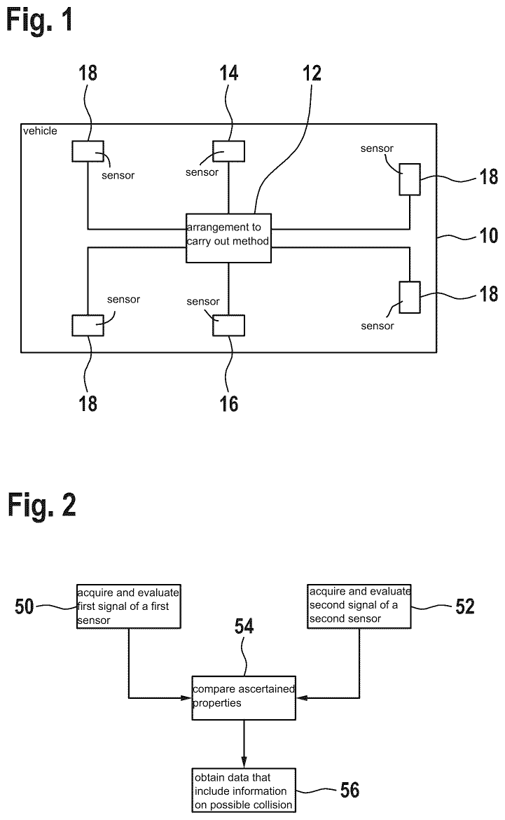

FIG. 1 shows a schematic, highly simplified representation of a vehicle, which is denoted overall by reference sign 10. Provided in this vehicle is an arrangement 12, which is provided for carrying out the method illustrated herein and can also be referred to as evaluation electronics. The arrangement 12 can be implemented in hardware and/or software and can also be integrated into a control unit of the vehicle 10.

The representation furthermore shows a first sensor 14 and a second sensor 16, which are arranged on opposite sides of the vehicle 10. These two sensors 14, 16 provide signals that are evaluated for detecting, in particular, minor collisions. This means that at least one property or at least one feature of these signals can provide an indication of a collision that may have occurred. At least one signal property is thus characterized by, or is indicative of, a collision that has occurred.

The representation also shows four further sensors 18, which likewise provide signals that are evaluated for the detection of collisions.

One property that can be taken into account in this case is, for example, the frequency of the sensor signal investigated. Furthermore, sensor signals of different sensors 14, 16 and/or 18 can be compared to one another. In this case, the comparison of opposite sensors 14, 16 and/or 18, such as the first sensor 14 and the second sensor 16, is in particular expedient.

FIG. 2 shows a flow chart of a possible sequence of the method presented. In a first step 50, a first signal of a first sensor is acquired and evaluated. This results in a signal strength-independent property of the first signal, e.g., in the frequency of this signal. In a second step 52, a second signal of a second sensor is acquired and evaluated. This results in a signal strength-independent property of the second signal, e.g., in the frequency of this signal. The first step 50 and the second step can occur simultaneously. In particular, these steps 50, 52 can occur continuously and also at time intervals.

In a third step 54, the ascertained properties of the two signals are then compared. In a fourth step 56, data that comprise information on possible collisions are obtained therefrom. This means that the data show whether a collision, in particular a minor collision, has occurred. In this way, damage to the vehicle can be detected.

It should be noted that the frequency of a signal can be estimated from the signal curve of a sensor. In doing so, a frequency analysis can be carried out based on the measurement of the length of the signal. Reference is made in this respect to German Patent Application No. DE 10 2006 044 444 A1.

A sensor system can generate a first signal from which a second signal is derived. The frequency can then be determined as a function of a first length of a curve of the first signal and a second length of a second curve of the second signal. For this purpose, the first and second lengths can be determined as a function of an absolute summation of respective differences from successive values of the first and second summed-up signals. The frequency can subsequently be determined, for example, by forming the quotient of the first and second lengths.

This procedure is explained below:

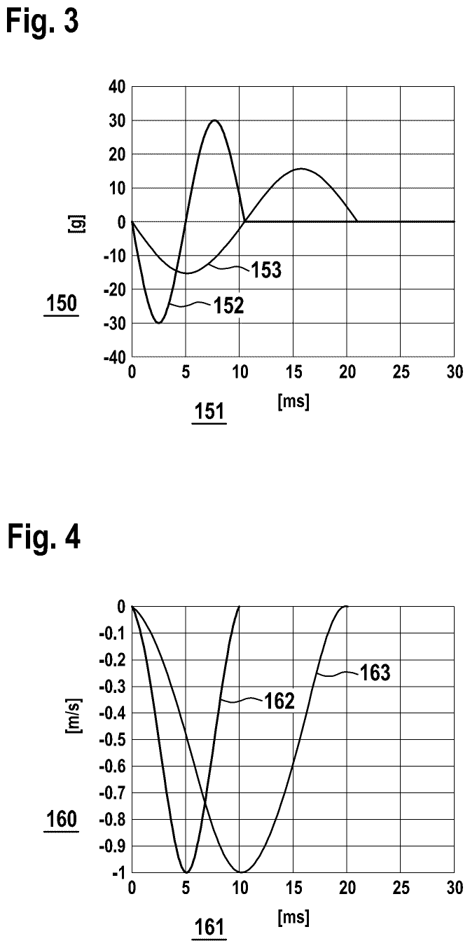

In order to identify collision objects, the frequency analysis is of great advantage for both pedestrian protection and other collision types. It is possible to determine the frequency via the minima of the acceleration signal and of the first integral or also of the second integral. This results, for example, from FIG. 3.

FIG. 3 shows the time on the abscissa 151 and the acceleration on the ordinate 150. Two signals 152 and 153 are shown over time. The signal 152 has a circular frequency of 600 Hz, wherein the signal 153 has a circular frequency of 300 Hz.

FIG. 4 shows the integrals in this respect. In this case, the signal 162 is the signal with the circular frequency 600 Hz, and the signal 163 is the signal with the circular frequency 300 Hz.

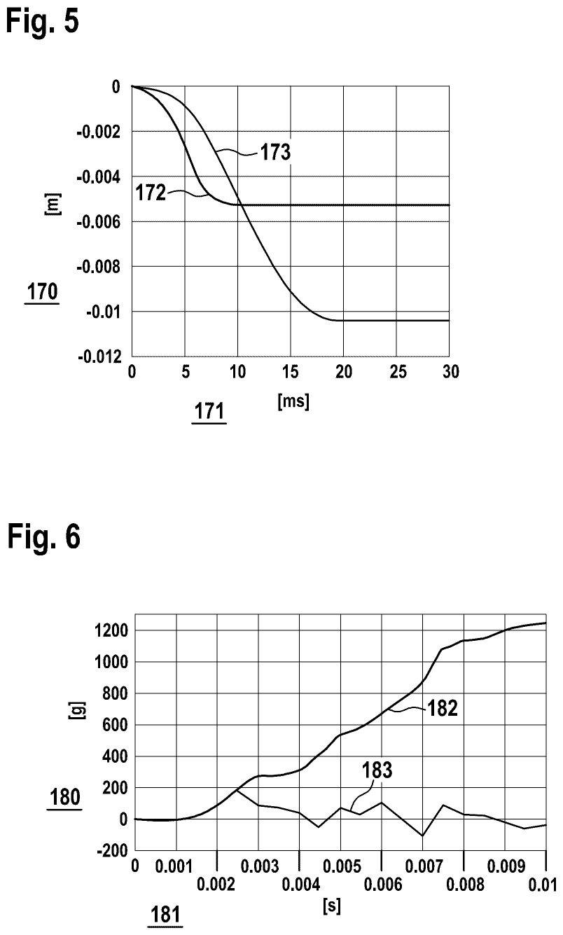

According to FIG. 5, the signal 172 is the signal with the circular frequency 600 Hz and the signal 173 is the signal with the circular frequency 300 Hz. The frequency can then be reconstructed in two ways:
1. The frequency can be calculated from the minimum of the acceleration and the minimum of the first integral of the acceleration. The frequency then results by means of a division.

$$ω = 2 \frac{\overline{a}}{\overline{dv}} \qquad ( 1 )$$

2. The frequency can be calculated from the minimum of the first integral and the minimum of the second integral. A division can then be used here as well.

$$ω = π \frac{\overline{dv}}{\overline{ds}} \qquad ( 2 )$$

This method has potential for improvement with respect to the following points:
A. If the signal does not end after one period as described above, but the vibration is maintained for a longer time, no new maxima of the acceleration and of the first integral are reached. The first calculation rule thus continues to provide a correct frequency estimate. In contrast, the second integral continues to decrease continuously and reaches new minimum values; the second calculation rule is therefore no longer valid and frequencies that are too low are increasingly estimated.
B. Only the first half-wave, or the first full period, is acquired. The further course in an actual, generally non-harmonic signal is only acquired if new minima of the signal or of the first and second integrals are associated therewith. If this is not the case, the frequency estimate no longer changes, even if the signal itself changes its frequency. Such an example can be seen in FIG. 8. It shows a diagram with the time plotted on the abscissa 181 and the acceleration plotted on the ordinate 180. The signal 183 denotes the acceleration. The signal 182 denotes the length of the acceleration signal. For example, the distinction as to whether the minima or maxima must be calculated also cannot be represented using a continuous transition of bumper regions with a negative acceleration and a positive acceleration.

It is therefore proposed that the length of the signal or of the signal path is taken into account, rather than the minima of the signal of the first and/or of the second integral. In this case, the absolute difference of successive values can preferably be summed up.

This is shown in FIG. 8 by the curve 182. The lengths of the signals of the first integral and of the second integral are denoted as follows:

$$length ( a ) = {\sum }_{i} \vert {a}_{i} - {a}_{i - 1} \vert \qquad ( 3 a )$$

$$length ( dv ) = \sum \vert {dv}_{i} - {dv}_{i - 1} \vert = {\sum }_{i} \vert {a}_{i} \vert \qquad ( 3 b )$$

$$length ( ds ) = {\sum }_{i} \vert {ds}_{i} - {ds}_{i - 1} \vert = {\sum }_{i} \vert {v}_{i} \vert \qquad ( 3 c )$$

The present invention is further explained below with reference to the acceleration signals. However, it is also possible to use other accident signals.

In (3b), the fact that the difference between two successive integrator values is the acceleration value associated with this cycle was utilized. Accordingly, in (3c), the difference between two successive values of the second integral is the value of the first integral in this cycle.

FIG. 6 shows the length of the acceleration signal. It can be seen that the length of the signal follows the signal itself until the first signal maximum. In contrast, the subsequent return is taken into account in the length without sign and results in a further increase. The length of the signal is thus a measure of the “movement in the signal.” Accordingly, the length of the first integral is a measure of the “movement in the first integral;” high-frequency vibrations are now characterized by the fact that they build up relatively little integral, i.e., a given “movement in the signal” results in relatively little “movement in the integral.”

It is therefore expedient to use the ratio of the lengths instead of the amplitude ratio (1). The following is thus obtained as improved frequency estimate:

$$ω = \frac{length ( a )}{length ( dv )} = \frac{{\sum }_{i} \vert {a}_{i} - {a}_{i - 1} \vert}{{\sum }_{i} \vert {v}_{i} - {v}_{i - 1} \vert} = \frac{{\sum }_{i} \vert {a}_{i} - {a}_{i - 1} \vert}{{\sum }_{i} \vert {a}_{i} \vert} \qquad ( 4 )$$

The index i runs across all calculation cycles from the start of the algorithm. The frequency thus results as the quotient of the length of the acceleration signal and the absolute integral of the acceleration signal.

For ascertaining a relative signal strength at a position, both a sensor near this position and a sensor at a clear distance to this position, e.g., on the other side of the vehicle, are required.

In order to cover the entire vehicle periphery, a correspondingly large number of sensors is required. One type of relative signal strength ascertainment is shown in German Patent Application No. DE 10 2007 052 159 A1.

When ascertaining the relative signal strength ascertainment, the signals of two sensors are compared, where appropriate after a pre-processing, such as filtering, window integral formation. This can be carried out by difference or quotient formation. Moreover, normalization via the vehicle velocity can be carried out in order to account for the speed-dependent influence of driving maneuvers. Higher accelerations or signal strengths occur at high speeds.

1-10. (canceled)

11. A method for detecting a contact on a vehicle, the method comprising the following steps:
evaluating and comparing acceleration signals from at least two sensors to one another, wherein at least one signal strength-independent property of the signals is taken into account; and
detecting the contact on the vehicle based on the evaluation and comparison.

12. The method according to claim 11, wherein a frequency of each of the signals is acquired as the signal strength-independent property of the signals.

13. The method according to claim 11, wherein the method is used to detect a contact which results in minor damage.

14. The method according to claim 11, wherein a frequency is taken into account as at least one property of the at least one signal strength-independent property.

15. The method according to claim 11, in which a first sensor and a second sensor are used.

16. The method according to claim 15, wherein the first sensor and the second sensor are mounted on opposite sides of the vehicle.

17. The method according to claim 15, wherein further sensors are used.

18. The method according to claim 11, wherein a relative signal strength ascertainment is carried out.

19. An arrangement for detecting a contact on a vehicle, the arrangement configured to:
evaluate and compare acceleration signals from at least two sensors to one another, wherein at least one signal strength-independent property of the signals is taken into account; and
detect the contact on the vehicle based on the evaluation and comparison.

20. A non-transitory machine-readable storage medium on which is stored a computer program for detecting a contact on a vehicle, the computer program, when executed by a computer, causing the computer to perform the following steps:
evaluating and comparing acceleration signals from at least two sensors to one another, wherein at least one signal strength-independent property of the signals is taken into account; and
detecting the contact on the vehicle based on the evaluation and comparison.
